(19) United States
(12) Patent Application Publication
(10) Pub. No.: US 2013/0189998 A1
(43) Pub. Date: Jul. 25, 2013

(54) SIM DEVICE

(71) Applicant: Mark Julian Stewart, Chelmsford (GB)

(72) Inventor: Mark Julian Stewart, Chelmsford (GB)

(21) Appl. No.: 13/825,355

(22) PCT Filed: Aug. 31, 2011
(86) PCT No.: PCT/GB2011/051634

§ 371 Date: Apr. 8, 2013

(30) Foreign Application Priority Data
Sep. 21, 2010 (GB) 1015748.5

(51) Int. Cl. H04W 40/20

(52) U.S. Cl. CPC H04W 40/20
USPC 455/445

(57) ABSTRACT

There is provided a SIM device (20) to be connected to a SIM card (10) for a communications device, the device having a bay (35) for receiving that SIM card, and the SIM card being associated with a first communications network route. The SIM device comprises a substrate (21) having first and second surfaces (23,22), the SIM card being mountable to the first surface. A first set of electrical contacts (26) are arranged on the first surface of the substrate to engage corresponding card contacts (15) on the SIM card. A second set of electrical contacts (31) are arranged on the second surface of the substrate for engagement with corresponding contacts in the bay of the communications device. A microprocessor (25) is provided on the substrate and is electrically connected to the device contacts and associated with a second communications network route. When a call is initiated the microprocessor determines from characteristics of a unique call identifier associated with the call recipient the most appropriate communications network route through which to route the call. A method of making or routing a phone call using such a SIM device is also provided.

The present invention relates to a Subscriber Identity Module (SIM) device for use with a communications device fitted with a SIM card, and more particularly to a SIM device adapted to reroute calls depending on the unique identifier of the call recipient.

Most developed countries of the world have at least three mobile network operators (MNOs) each licensed to offer mobile communications services to consumers and each having the necessary infrastructure in place, particularly a network of transmitters and call switching facilities. With so few MNOs in each country and thus so little competition to drive down prices, consumers may be charged inflated prices when making calls, particularly calls to foreign territories. It is those calls to foreign territories with which the present invention is particularly concerned.

Calling cards or phone cards are commonly available for making international calls from mobile telephones at a very low rate. Generally, these cards are available from newsagents and supermarkets and include two important numbers: the telephone number of the card company and a PIN number concealed by a removable panel. A person wishing to make a call using the card simply removes the panel to reveal the PIN, dials the telephone number of the switching office and waits for a voice message prompting the user to enter the PIN using the phone's keypad. Once the PIN has been successfully entered and the account recognised by the switching station, a voice message discloses the account credit and prompts the user to enter the recipient's unique identifier (telephone number). Once the unique identifier has been entered the switching office then connects the caller to the recipient.

Generally, the switching station telephone number is a local number or other low cost number which the mobile telephone operator would charge very little to call. Indeed, if the call is made on a phone covered by a contract providing a predefined amount of call time, the call to the switching station would very likely be covered by that bundle. Because the international part of the call is handled entirely by the phone card company, in that it initiates and terminates the call, it can control the cost of the call, and to appeal to international callers it obviously charges a very low rate.

The problem with such calling cards is the inconvenience of having to carry the card or remember the telephone number and the PIN. However because the recipient's number is usually stored in the telephone's contacts list and most telephones do not permit the contact list to be accessed when making a call, it is necessary to remember the recipient's number or to make a note of it prior to making the call.

It is therefore an object of the present invention to overcome the above problems by providing a convenient way of making inexpensive international calls from a mobile communications device.

According to the present invention, there is provided a SIM device to be connected to a SIM card installed in a communications device having a bay for receiving the SIM card associated with a first communications network route, the SIM device comprises:

a substrate having first and second surfaces, the SIM card being mountable to the first surface;

a first set of electrically conductive device contacts arranged on the first surface of the substrate for engagement with corresponding electrically conductive card contacts on the SIM card;

a second set of electrically conductive device contacts arranged on the second surface of the substrate for engagement with corresponding electrically conductive contacts in the bay of the communications device;

a microprocessor provided on the substrate and electrically connected to the device contacts and associated with a second communications network route,

wherein the microprocessor is configured when a call is initiated to determine from characteristics of a unique identifier associated with the call recipient the most appropriate communications network route through which to route the call.

The first and second communications network routes may have similarities. In particular, both routes may include an initial wireless stage whereby during a call the mobile communications device may communicate to a local base station using a pair of designated frequencies. From there, both routes pass through a mobile telephone switching office and then over the public switched telephone network. It is here where the two routes are likely to take different paths. The first communications network route is likely to adopt the shortest path to the recipient, whereas the second communications network route is likely to pass to a switching device connected to the public switched telephone network and managed by the SIM device provider. Most probably, the mobile network operator terminates the call at that switching device. A new call is initiated by the SIM device provider and terminated at a recipient's communications device using the shortest possible path.

Advantageously the first surface may be furnished with an adhesive by which the SIM device may be adhered to the SIM card. Preferably this is a narrow band of adhesive disposed at least partway around the periphery of the substrate. For example, the band may extend along one edge of the substrate or around several edges. Alternatively, the adhesive layer may occupy most of the first surface, but preferably it does not overlie the contacts so as to avoid inhibiting the electrical connection between the SIM card and the SIM device.

The adhesive may be applied immediately prior to the SIM device being mounted to the SIM card or may be applied during the manufacture of the SIM device. Preferably the adhesive layer is applied during manufacture of the SIM device and most preferably a releasable backing sheet may be arranged to overlie the adhesive layer prior to attachment to a SIM card.

Preferably the SIM device is no larger than the SIM card so as not to extend beyond the periphery of the SIM card when mounted thereto. Provided the SIM device is no larger than the SIM card they should both fit into the SIM bay of any communications device, particularly if the substrate is sufficiently thin. Preferably the substrate is made of a flexible plastics material so that it may be easily applied to and peeled from the SIM card.

Preferably the unique identifier comprises a string of symbols, and most preferably a string of numbers defining a telephone number. The microprocessor may be adapted to compare that string of symbols with at least one string of symbols stored in its memory and to route the call through the second communications network route in the event that those strings match. For instance, the string of symbols stored in the memory may relate to the international access code and the country calling code for each country for which the SIM device provider offers low cost calls. Thus, the microprocessor may compare the international access code and the country calling code of the recipient's number with those stored in its memory to determine whether a low cost call can be made via the SIM device provider. The string of symbols may relate not only to international access codes and country calling codes, but also telephone numbers associated with high cost calls when made from mobile communications devices.

In the event that the call is to be transmitted over the second communications network route, the microprocessor prefixes the recipient's unique identifier with a low cost telephone number assigned to the SIM device provider's switching station.

Advantageously, the microprocessor may include a lookup table for translating strings of symbols into a preferred format. For instance, the lookup table may be configured to translate a “+” symbol at the start of any string into the designated international access code for a particular country, for example “00”. Nowadays many countries use the “+” symbol rather than their designated international access code so as to reduce the number of digits necessary for making an international call.

In a preferred embodiment the microprocessor may be adapted to receive through a control channel network a code corresponding to the country in which it is instantaneously located and to compare that instantaneous country code with a table of country codes stored in its memory. Furthermore, the microprocessor may be adapted to route calls through the second communications network route only if the instantaneous country code matches any of the country codes stored in the memory. This feature is particularly useful since the SIM device provider may be able to offer low cost calls when made only from a selection of countries. Consequently, it is preferable to determine the instantaneous location of the communications device from which the call is to be made.

Furthermore, each country code may have a corresponding predefined unique identifier to be prefixed to the unique identifier of the call recipient when the second communications network route is selected. The corresponding predefined unique identifier may be the local telephone number assigned to the SIM device provider's switch for initiating and terminating the call.

According to a second aspect of the invention, there is also provided a method of making a phone call comprising the steps of:
providing a communications device fitted with a SIM card and the SIM device described above;
initiating a call to a recipient having a unique identifier comprising a string of symbols;
comparing a first predetermined number of the string of symbols with at least one string of symbols stored in the memory of the microprocessor; and
in the event that the strings do not match routing the call through a first communications network route or in the event that the first predetermined number of symbols of the unique identifier match any of the strings of symbols stored in the memory routing the call through a second communications network route.

By way of example only, one embodiment of the present invention will now be described in detail, with reference being made to the accompanying drawings, in which:

FIG. 1 is a front view of a conventional SIM card;

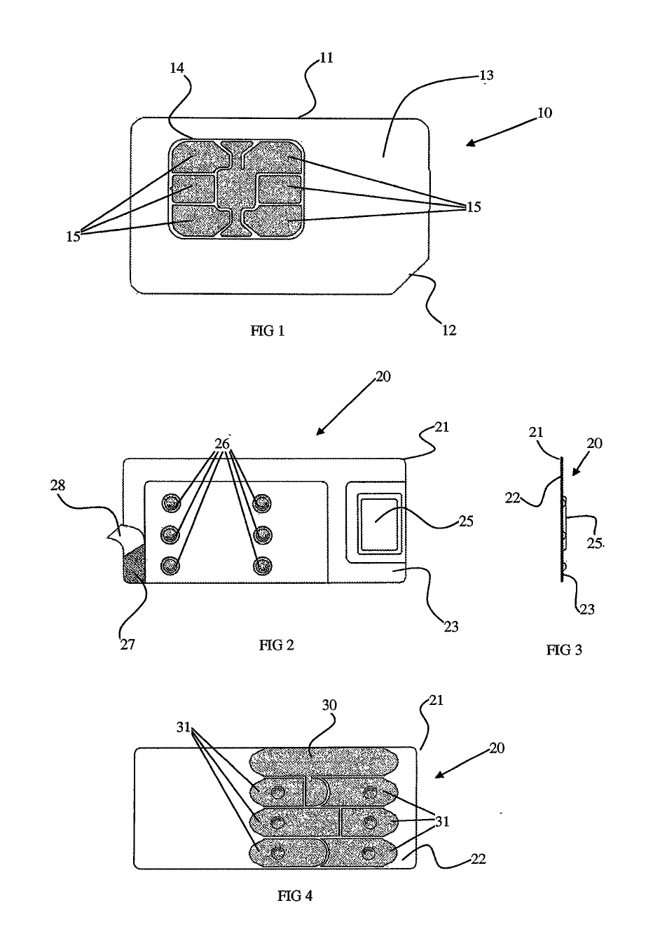

FIG. 2 is a rear view of a SIM device according to the invention;

FIG. 3 is an end view of the SIM device shown in FIG. 2;

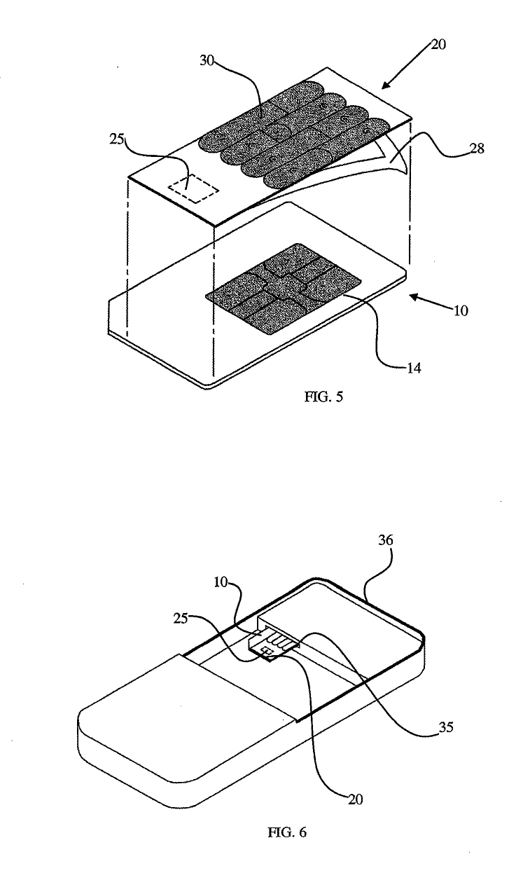

FIG. 4 is a front view of the SIM device shown in FIGS. 2 and 3;

FIG. 5 is a perspective view of the SIM device being mounted to the SIM card; and

FIG. 6 is a perspective view of the SIM device and SIM card being fitted to a mobile communications device.

Referring initially to FIG. 1, there is shown a conventional SIM card 10 that is adapted to be inserted into a mobile communications device such as a mobile telephone 36 (see FIG. 6). This particular SIM card 10 is known as a mini SIM card as it comprises a plastics substrate 11, which is 25 mm long, 15 mm wide and 0.76 mm thick and one of its corners 12 is chamfered to facilitate correct insertion into the SIM bay of the mobile telephone 36. The front surface 13 of the SIM card 10 is recessed to accommodate a rectangular panel 14 defining six distinct metallic contacts 15 each being electrically connected to a microprocessor (not shown) embedded within the substrate 11. The contacts 15 are configured in a particular way so as to align with corresponding contacts provided in the SIM bay when the SIM card 10 is fitted thereto.

The SIM card microprocessor holds data such as its unique serial number, a subscriber key for identifying the user, security authentication data, local network data, services accessible by the user, a PIN number and a PUK code. Usually, when a mobile telephone fitted with the SIM card 10 is switched on it looks for a control channel over which it can communicate via the closest base station to the mobile telephone switching office specific to the mobile network operator to which it is subscribed. To register on that network, the subscriber key must be transmitted through the control channel to the mobile network operator for verification. Once the mobile telephone is registered on the network, data relating to the mobile telephone's location is periodically sent over the control channel to the SIM card.

A call is initiated by entering the recipient's number into the mobile telephone keypad or selecting the recipient's number from the telephone's contacts list, which causes the recipient's number then to be transmitted over the control channel via the closest base station to the mobile telephone switching station. That station then selects a pair of frequencies over which the telephone and the closest base station will communicate during the call and also connects the call to the public switched telephone network over which the international recipient can be reached. Provided the mobile telephone and SIM card are equipped with calling line identity (CLI) software, the caller's telephone number is also transmitted over the control channel and eventually to the recipient's telephone so the caller's identity is apparent to the recipient prior to taking the call. The above SIM card 10 is entirely conventional and is discussed here merely for background information.

Referring now to FIGS. 2 to 4, there is shown a SIM device 20 comprising a substrate 21 made from a flexible plastics material and having opposed front and rear surfaces 22,23. Towards one end of the rear surface 23 there is provided a microprocessor 25 and at the other end of that surface there is provided an array of six circular contacts 26 electrically connected to the microprocessor 25 by metallic tracks (not shown). Also provided on the rear surface 23 is a thin layer of adhesive 27 extending partway around its periphery. The adhesive layer is covered by a correspondingly shaped releasable backing 28. On the front surface 22 of the substrate 21 there is provided a generally rectangular panel 30 extending across the width thereof, which panel defines eight metallic contacts, though only six of those are used. The six contacts 31 that are used are electrically connected to the microprocessor 25 by metallic tracks (not shown) and are aligned with the circular contacts 26 on the rear surface 23 and also the contacts 15 on the SIM card 10.

The SIM device microprocessor includes a memory in which there is stored a list of telephone number prefixes common to all telephone numbers for which the SIM device provider offers low cost calls. In this embodiment, the SIM device provider offers low cost calls to a selection of foreign countries and the telephone number prefixes in the memory are the international access code and the country calling code for each of those countries. The microprocessor is configured to analyse the recipient's telephone number to determine whether it is prefixed with one of the telephone number prefixes stored in its memory. In the event that the recipient's telephone number includes one of those stored prefixes, the SIM device microprocessor is configured to prefix the recipient's telephone number with a local number assigned to the SIM device provider's soft switch. Soft switches are well known and serve to connect telephone calls from one phone line to another using VOIP.

The international access code for many countries of the world is “00”, though some countries have different access codes ranging from one to four digits. For example, the international access code for Belarus is “810”. However, in an attempt to shorten the length of international telephone numbers, it is now possible simply to replace the international access code with “+”, though it is still necessary to include the country calling code. For example, the international access code for the UK is “00” and the country calling code for the USA is “1”, so when calling a recipient in the USA from the UK, the recipient number should be prefixed with “001” or “+1”. To ensure that all numbers sent to the soft switch are in a consistent format, the microprocessor includes a table for translating “+” symbols into the appropriate international access codes, most commonly “00”.

Different SIM devices 20 may be configured differently depending on the services offered by the SIM device provider. In this embodiment, the SIM device provider offers low cost calls only from its home territory, i.e. the UK, so it is preferable for all calls made outside the UK to be routed through the mobile network operator associated with the SIM card. As such, the SIM device microprocessor 25 is adapted to receive data from the SIM card 10 relating to its instantaneous location, typically in the form of a mobile country code (MCC). The microprocessor 25 is configured to compare that data with the country code stored in its memory and forward calls to the soft switch only in the event that the data received from the SIM card 20 matches one or more country code stored in its memory.

Each SIM device 20 has a corresponding account which is administered by the SIM device provider and must be activated prior to use.

The activation process may be completed online or by telephone and typically requires the user's details, particularly the user's telephone number, to be registered with the SIM device provider and a minimum amount of credit to be purchased. With reference to FIGS. 5 and 6, the SIM device 20 is then mounted to the SIM card 10 by removing the releasable backing 28 to reveal the adhesive layer 27 and presenting the rear surface 23 of the SIM device 20 to the front surface 13 of the SIM card 10 such that the corresponding contacts 15,26 engage. The SIM card 10 and SIM device 20 may then be inserted into the telephone SIM bay 35 such that the six metallic contacts 31 on the SIM device engage the contacts (not shown) of the SIM bay. Since the SIM device is interposed between the telephone SIM bay and the SIM card 10, the data transmitted between those components passes through the SIM device.

In use, when the mobile telephone 36 is switched on in a particular country it communicates to a mobile telephone switching station over a designated control channel. Once the registration process is completed, the MCC is periodically transmitted over the control channel to the SIM card 10 and the SIM device microprocessor 25, which compares that code to one or more stored in its memory. If those codes match, the microprocessor 25 adopts the interception mode.

While in the interception mode, a recipient number may be dialled into the telephone keypad or selected from the contacts list in the usual way to initiate a call. The SIM device microprocessor intercepts the recipient's number and compares it to the telephone number prefixes stored in its memory. If the recipient's telephone number does not include one of those telephone number prefixes the microprocessor 25 will allow the call to be routed through the mobile network operator associated with the SIM card 10.

If indeed the recipient's telephone number includes one of those prefixes then the microprocessor will prepare the recipient's number so that the call may be routed via the soft switch. First, the international access code of the recipient's number is analysed and if necessary translated into the preferred format using the MCC and the lookup table. Specifically, the microprocessor determines its current location from the MCC and from that selects the correct international access code from the lookup table. Second, the recipient's translated number is then prefixed with a local number corresponding to the soft switch of the SIM device provider and transmitted over the control channel with the CLI to the mobile telephone switching station. That station then selects a pair of channels over which the telephone and base station shall communicate with each other and also routes the call through the public switched telephone network and terminates it at the soft switch. Thus, the only cost incurred by the caller is that of a local call, which would most likely be included in the callers call bundle.

The soft switch uses the CLI to access the caller's SIM device account and check the available credit before relaying that information to the caller. The call is subsequently routed to the recipient using the public switched telephone network. Since the SIM device provider is responsible for initiating the call from the soft switch and terminating the call outside the home territory, it may set its own tariff which may be significantly lower than that of the mobile network operator.

1. A SIM device to be connected to a SIM card installed in a communications device having a bay for receiving that SIM card associated with a first communications network route, the SIM device comprises:
a substrate having first and second surfaces, the SIM card being mountable to the first surface;
a first set of electrically conductive device contacts arranged on the first surface of the substrate for engagement with corresponding electrically conductive card contacts on the SIM card;
a second set of electrically conductive device contacts arranged on the second surface of the substrate for engagement with corresponding electrically conductive contacts in the bay of the communications device; and
a microprocessor provided on the substrate and electrically connected to the device contacts and associated with a second communications network route,
wherein the microprocessor is configured when a call is initiated to determine from characteristics of a unique identifier associated with the call recipient the most appropriate communications network route through which to route the call.

2. A SIM device as claimed in claim 1, wherein the first surface is furnished with an adhesive layer by which the SIM device may be adhered to the SIM card.

3. A SIM device as claimed in claim 2, wherein the adhesive layer comprises a band disposed at least partway around the periphery of the substrate.

4. A SIM device as claimed in claim 2 further comprising a releasable backing sheet arranged to overlie the adhesive layer prior to use.

5. A SIM device as claimed in claim 1, which is no larger than the SIM card so as not to extend beyond the periphery of the SIM card when mounted thereto.

6. A SIM device as claimed in claim 1, wherein the substrate is made from a flexible plastics material.

7. A SIM device as claimed in claim 1, wherein the unique identifier comprises a string of symbols and the microprocessor is adapted to compare that string of symbols with at least one string of symbols stored in its memory and to route the call through the second communications network route in the event that those strings or an appropriate part thereof match.

8. A SIM device as claimed in claim 1, wherein the microprocessor includes a lookup table for translating strings of symbols into a preferred format.

9. A SIM device as claimed in claim 8, wherein the lookup table is configured to translate a “+” symbol at the start of any string into “00”.

10. A SIM device as claimed in claim 1, wherein the microprocessor is configured to prefix the unique identifier with a predefined routing code for a switching station when the second communications network route is selected, thereby causing the call to be forwarded to the switching station and thence to the intended recipient.

11. A SIM device as claimed in claim 1, wherein the microprocessor is adapted to receive through a control channel network a code corresponding to the country in which it is instantaneously located and to compare that instantaneous country code with a table of country codes stored in its memory, the microprocessor being adapted to route calls through the second communications network route only if the instantaneous country code matches any of the country codes stored in the memory.

12. A SIM device as claimed in claim 14, wherein each country code has a corresponding predefined unique identifier to be prefixed to the unique identifier of the call recipient when the second communications network route is selected.

13. A method of making a phone call comprising the steps of:
providing a communications device fitted with a SIM card and the SIM device defined in claim 1;
initiating a call to a recipient having a unique identifier comprising a string of symbols;
comparing a predetermined number of symbols of the unique identifier with at least one string of symbols stored in the memory of the microprocessor;
in the event that the none of the strings match routing the call through a first communications network route or in the event that the first predetermined number of symbols of the unique identifier match any of the strings of symbols stored in the memory routing the call through a second communications network route.

14. A SIM device as claimed in claim 10, wherein the microprocessor is adapted to receive through a control channel network a code corresponding to the country in which it is instantaneously located and to compare that instantaneous country code with a table of country codes stored in its memory, the microprocessor being adapted to route calls through the second communications network route only if the instantaneous country code matches any of the country codes stored in the memory.
